(19) United States
(12) Patent Application Publication
(10) Pub. No.: US 2012/0249049 A1
(43) Pub. Date: Oct. 4, 2012

(54) PORTABLE SOLAR POWER FRAME AND BATTERY BANK ASSEMBLY

(76) Inventors: Mark M. Hixson, Hixson, TN (US); Robert P. Creswell, Chattanooga, TN (US)

(21) Appl. No.: 13/435,712

(22) Filed: Mar. 30, 2012

Related U.S. Application Data
(60) Provisional application No. 61/470,874, filed on Apr. 1, 2011.

(51) Int. Cl. H01M 10/46; H01M 2/10; H01M 2/20

(52) U.S. Cl. 320/101; 429/158; 429/99

(57) ABSTRACT

A portable solar power frame and battery bank assembly is provided. The portable solar power frame and battery bank assembly apparatus is configured for use with a vending machine, or like electrically powered device, as original equipment or as a retrofit enhancement device to an existing vending machine, or like electrically powered device. The solar power frame is configured to capture sunlight and convert the captured sunlight into electricity, thereby to provide solar power to charge the battery bank and thereby power the machine or device

### CROSS-REFERENCE TO RELATED APPLICATION(S)

The present non-provisional patent application claims the benefit of priority of U.S. Provisional Patent Application No. 61/470,874, which is entitled “PORTABLE SOLAR POWER FRAME AND BATTERY BANK ASSEMBLY”, which was filed on Apr. 1, 2011, and which is incorporated in full by reference herein.

### FIELD OF THE INVENTION

The technology described herein relates generally to the fields of solar power systems, batteries, vending systems, and alternative and traditional power sources. More specifically, this technology relates to a portable solar power frame and battery bank assembly for use, combined or individually, with vending machines, or like electrically powered devices, or as a stand-alone system.

### BACKGROUND OF THE INVENTION

Vending machines are known in the background art, and in many areas may appear ubiquitous. However, since many vending machines require a reliable power source, such as that provided by traditional AC power on the power grid, to provide refrigeration, light, control of electronics, or the like, use of vending machines in all places is limited. By way of example, remote locations without power include county or state fairgrounds, craft shows, festivals, the desert, parks, athletic events, parking lots, and the like.

Additionally, even in places deemed to have generally reliable power, such as locations proximate to the traditional power grid, vending machines are not fully self-sustaining, because even the most reliable power sources have some unexpected interruptions or scheduled downtime. By way of example, loss of power to a vending machine for an extended period of time may cause food and drink products to warm and subsequently spoil.

Furthermore, known vending machines, and like electrical devices that pull power directly from the traditional power grid, typically have a significant carbon footprint. Such machines are not “green” or environmentally friendly.”

Related utility patents known in the art include the following: U.S. Pat. No. 6,263,674, issued to Fileman et al. on Jul. 24, 2001, discloses a solar-powered mobile vending apparatus. The panels are secured in a horizontal position to a base and mounted to a top of the vending machine for converting solar energy to electrical energy for powering the vending apparatus.

The foregoing patent information reflects the state of the art of which the inventors are aware and is tendered with a view toward discharging the inventors' acknowledged duty of candor in disclosing information that may be pertinent to the patentability of the technology described herein. It is respectfully stipulated, however, that the foregoing patent and other information do not teach or render obvious, singly or when considered in combination, the inventors' claimed invention.

### BRIEF SUMMARY OF THE INVENTION

In various exemplary embodiments, the technology described herein provides a portable solar power frame and battery bank assembly for use with a vending machine, or like electrically powered device. The apparatus is adapted for easy portability and use as a retrofit enhancement device to an existing vending machine, or like electrically powered device. Additionally, in an alternative embodiment, the apparatus is adapted for use with a vending machine, or like electrically powered device, as original equipment and can be integrally formed.

In one exemplary embodiment, the technology described herein provides a portable solar power frame and battery bank assembly apparatus for use with a vending machine, or like electrically powered device, as a retrofit enhancement device.

The apparatus includes a solar power frame. The solar power frame includes a multiplicity of solar panels coupled one to another in a solar panel array. The solar power frame is configured to capture sunlight and convert the captured sunlight into electricity, thereby to provide solar power to charge a battery bank and power the vending machine or other electrical device.

The solar power frame includes a multiplicity of drop-down hinges, or like devices, to allow for the folding of the solar power array formed by the multiplicity of solar panels.

The solar power frame includes multiple support legs. The support legs are removable and foldable in various embodiments. The support legs are configured to lock in place when in use or when in storage.

In at least one embodiment, the solar panel array is configured to fold to one stack of six panels, thereby providing compactness and portability. The solar panel array is configured to be lightweight such that one person can work with the array and “retrofit” an existing vending machine.

In at least one embodiment, the solar panel array is configured to provide an advertisement, logo, text, or the like. By way of example, the solar panel array is configured in one embodiment to be viewed as a bottle shape when utilized with a vending machine for colas, or like products.

The apparatus also includes a battery bank assembly. The battery bank assembly includes a multiplicity of batteries electrically coupled to one another and configured to store power for supplying power to the vending machine, or like device.

The apparatus includes an inverter. The inverter is configured to convert the DC power from the battery bank into AC power which the machine is originally configured to utilize.

The apparatus includes a combiner to combine the multiple inputs from the multiple solar panels in the solar panel array.

The apparatus further includes casters. The casters provide easy transportability of the battery bank assembly.

In another exemplary embodiment, the technology described herein provides a vending machine, or similar electronic device having a portable solar power frame and battery bank assembly as original equipment.

In yet another exemplary embodiment, the technology described herein a battery bank assembly apparatus for use with a vending machine, or like electrically powered device. In this embodiment, the battery bank assembly is utilized to power the vending machine when no traditional power source is available. Additionally, in this embodiment, the battery bank assembly is utilized without coupling to a solar power device.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front perspective view of a vending machine representative of vending machines known in the prior art;

FIG. 2 is a front perspective view of a battery bank assembly configured for connectivity to and use with the vending machine depicted in FIG. 1, according to an embodiment of the technology described herein;

FIG. 3 is a front perspective view of the battery bank assembly depicted in FIG. 2, shown in use with the vending machine depicted in FIG. 1, according to an embodiment of the technology described herein;

FIG. 4 is a schematic diagram, front planar view, for the battery bank assembly depicted in FIG. 2, according to an embodiment of the technology described herein;

FIG. 5 is a schematic diagram, side planar view, for the battery bank assembly depicted in FIG. 2;

FIG. 6 is a schematic diagram, top planar view, of a portable solar power frame configured for connectivity to and use with the battery bank assembly depicted in FIG. 2 to power the vending machine depicted in FIG. 1, according to an embodiment of the technology described herein;

FIG. 7 is a schematic diagram, side planar view, of the portable solar power frame depicted in FIG. 6;

FIG. 8 is a schematic diagram, end planar view, of the portable solar power frame depicted in FIG. 6; and

FIG. 9 is a schematic diagram, top planar view, of the portable solar power frame depicted in FIG. 6, wherein the solar panel array is further configured to provide an advertisement, logo, text, or the like, illustrating, in particular, a bottle shape for use with a cola vending machine.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a portable solar power frame and battery bank assembly for electrical coupling and use with a vending machine, or like electrically powered device. The apparatus is adapted for easy portability and use as a retrofit enhancement device to an existing vending machine, or like electrically powered device. Additionally, in an alternative embodiment, the apparatus is adapted for use with a vending machine, or like electrically powered device, as original equipment. Still furthermore, the battery bank assembly can be used without the portable solar power frame as an alternative power source to a vending machine or the like.

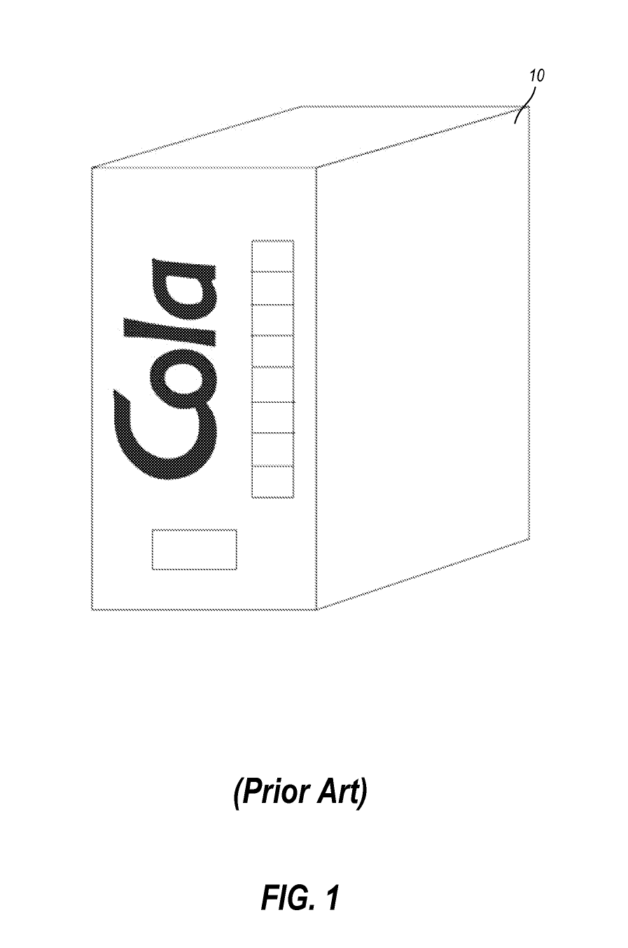

Referring now to FIG. 1, a front perspective view of a vending machine 10 representative of vending machines 10 known in the prior art is shown. By way of example, vending machines are known to disperse various products and food and beverage items, such as, for example, beverages, sundries, industrial supplies, toys, lotions, clothing, gifts, gift cards, electronics, novelty items, and so forth. Although a cola vending machine is depicted in FIG. 1, the technology described herein is utilized on various vending machines and other electrical devices. Additionally, the technology described herein is utilized on various vending machines and other electrical devices as either a retrofit device or as part of the original manufacture.

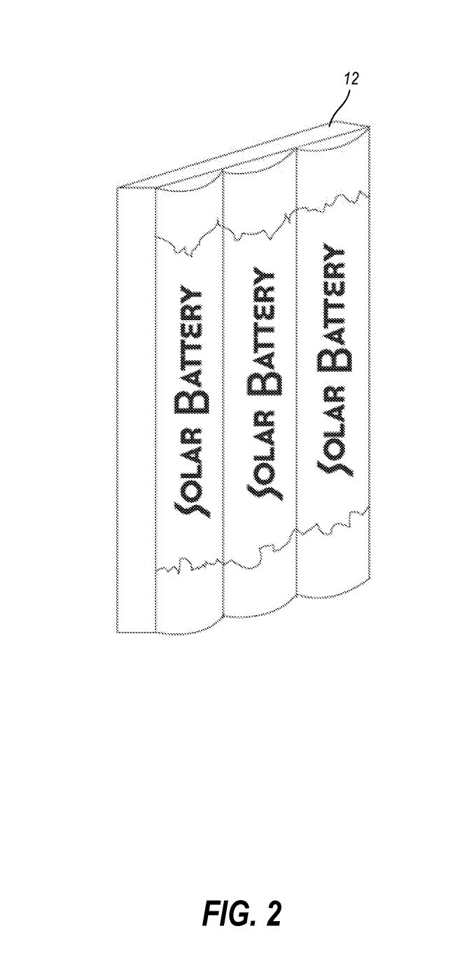

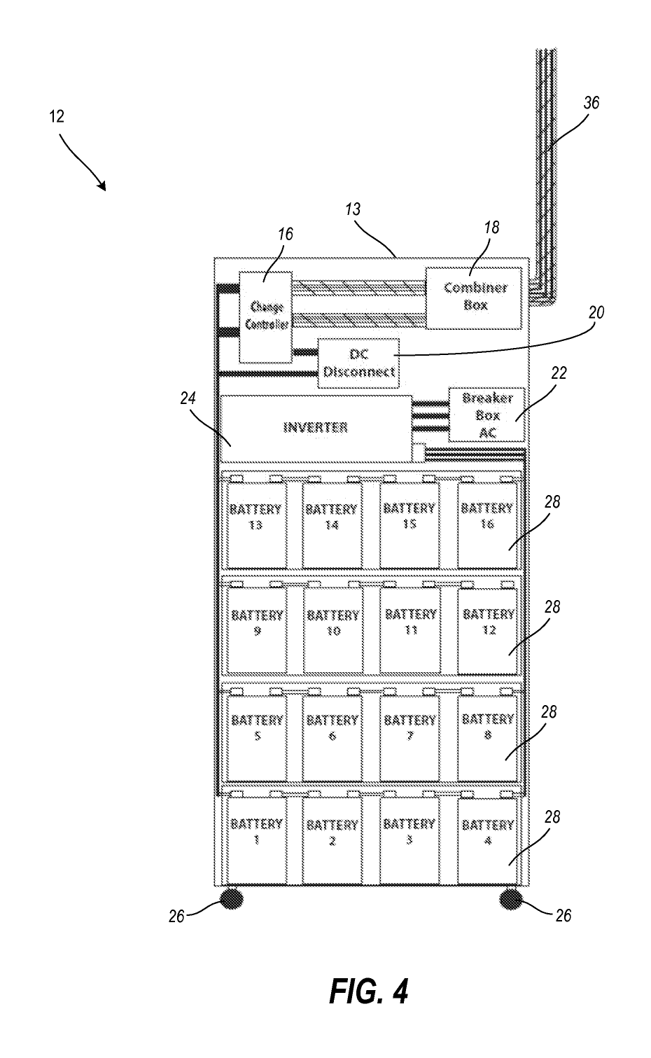

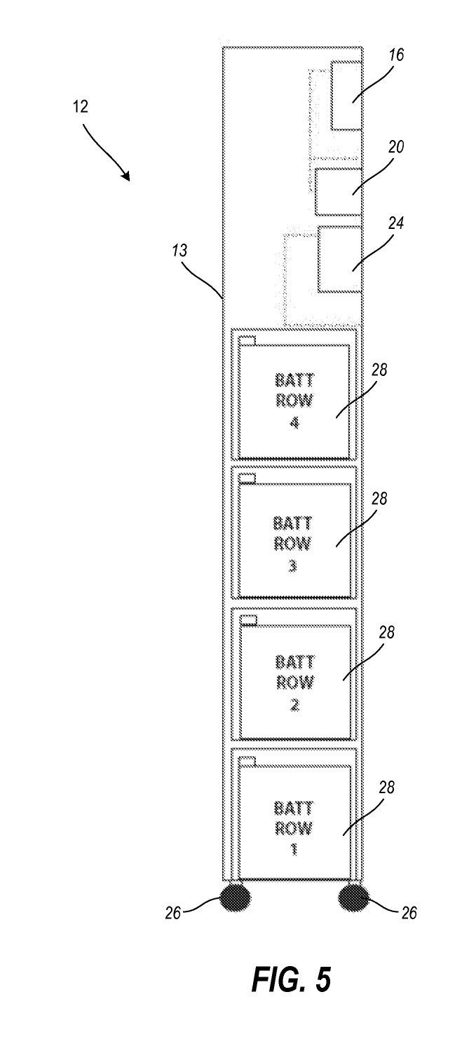

Referring now to FIG. 2, a front perspective view of a battery bank assembly 12 is shown. The battery bank assembly 12 is portable. As depicted in FIGS. 4 and 5, the battery bank assembly 12, and in at least one embodiment, includes a cabinet housing 13, including casters 26. The casters 26 provide for easy portability in rolling the battery bank assembly 12 for placement adjacent the vending machine 10. The battery bank assembly 12 is configured for connectivity to and use with the vending machine 10 depicted in FIG. 1, or similar electrical device for vending or other purposes.

In the embodiment depicted in FIG. 2, the battery bank assembly 12 is adapted for connectivity to and use with the vending machine 10, or like electrically powered device, as a retrofit enhancement device. As such, the battery bank assembly 12 is brought to an existing vending machine 10 for retrofit.

In various embodiments, the battery bank assembly 12 includes aesthetic and design elements including the shape of multiple cylindrical batteries adjacent to one another, and containing within the actual batteries, and other system elements disclosed below, charged by solar power to then power the vending machine 10. It at least one embodiment, the battery bank assembly 12 utilizes suggestive colors such as green suggesting the “environmental friendly” nature of the apparatus.

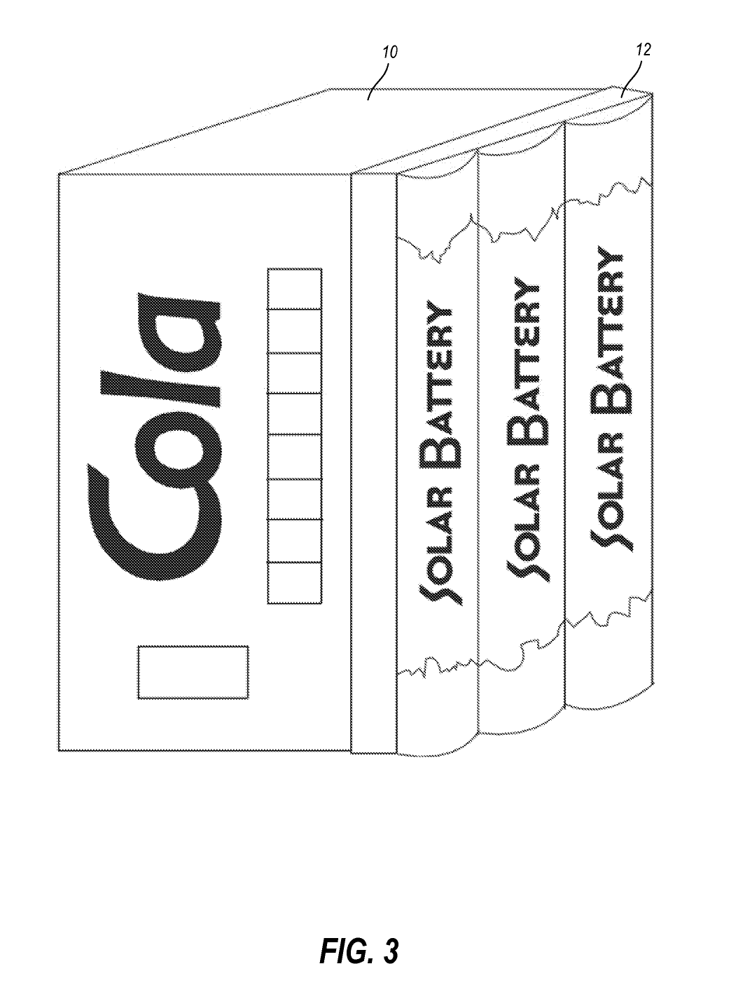

Referring now to FIG. 3, a front perspective view of the battery bank assembly 12 depicted in FIG. 2 is shown in use, after a retrofit installation, electrically coupled to the vending machine 10 depicted in FIG. 1. Visually, however, the combined vending machine 10 and battery bank assembly 12 will appear as a single vending unit to the consumer.

In an alternative embodiment (not shown), the battery bank assembly 12, as well as the solar power frame 14, is integrally formed with the vending machine 10 at the point of original manufacture and not as a retrofit assembly. In this embodiment, no retrofit installation is required. The original vending machine 10 equipment includes battery bank assembly 12.

Referring now to FIGS. 4 and 5, the battery bank assembly 12 is depicted in greater detail. FIG. 4 is a schematic diagram, front planar view of the battery bank assembly 12, illustrating, in particular, batteries 28, an inverter 24, breaker box 22, DC disconnect 20, change controller 16, combiner box, all located within cabinet housing 13 and casters 26. FIG. 5 is a schematic diagram, side planar view of the battery bank assembly 12 depicted in FIG. 4.

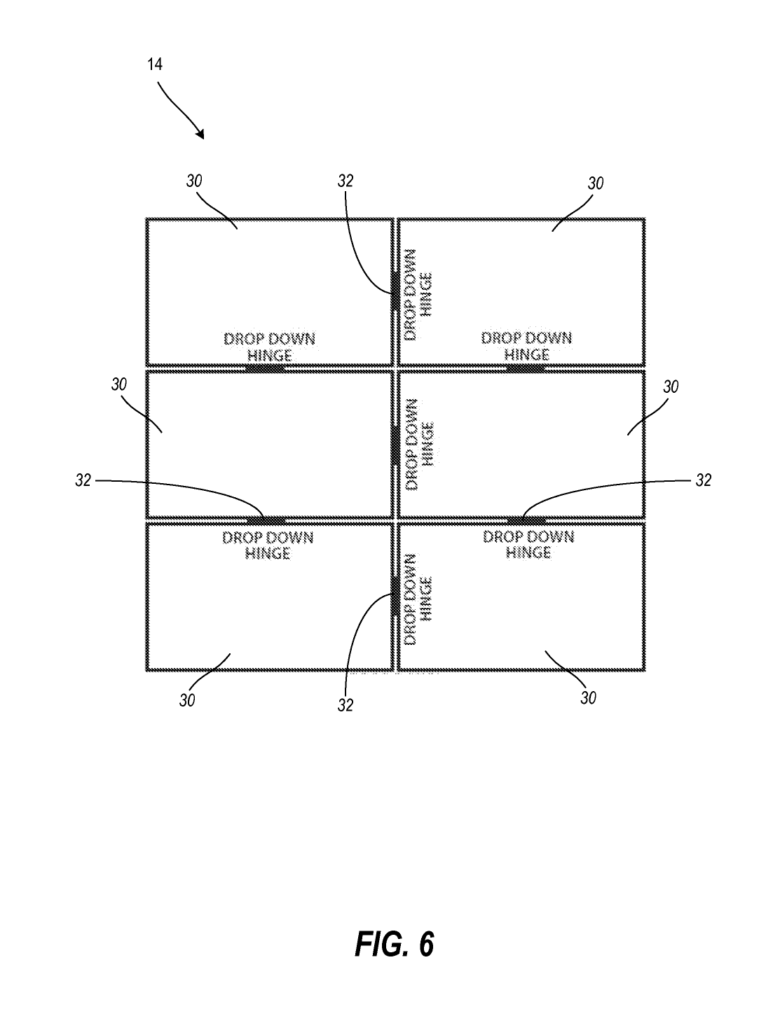

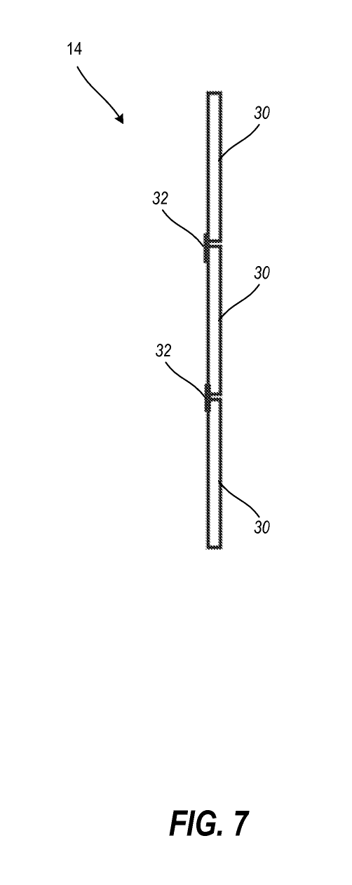

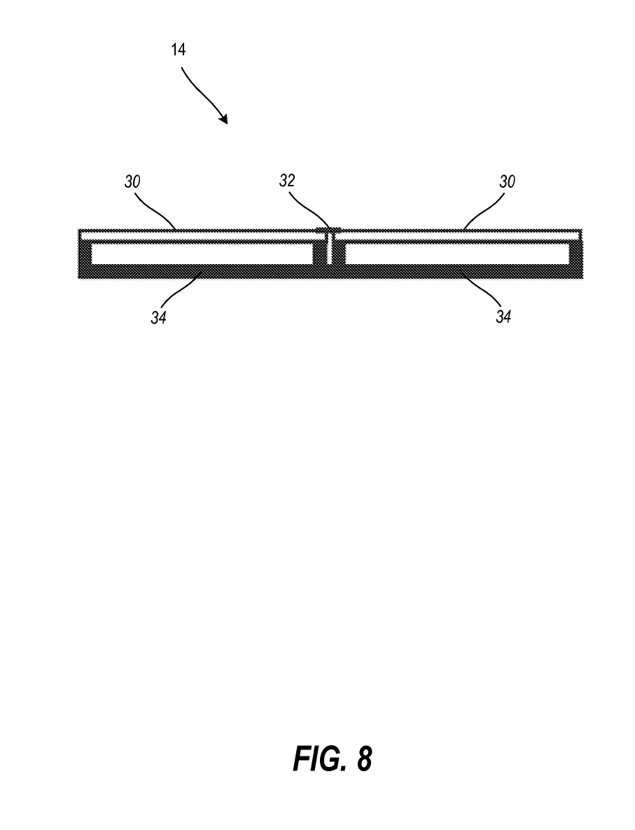

The battery bank assembly 12 is configured for portability and ease in coupling to a vending machine 10. A preconfigured wiring harness 36, for example, can be used to electrically couple the battery bank assembly 12 to an existing vending machine 10. Additionally, for embodiments disclosed below, including the solar power frame as depicted in FIGS. 6 to 9, the wiring harness 36, or like wiring harness is utilized to electrically couple the solar power frame to the battery bank assembly 12 for coupling at combiner box 18.

The battery bank assembly 12 includes a multiplicity of batteries 28. The batteries 28 are electrically coupled to one another. The batteries 28 are configured to store power for the subsequent supply of power to the vending machine 10, or like device. The arrangement, number, and power of the batteries 28 can vary based on power needs of the vending machine 10 supported. By way of example, some vending machines, such as a cola vending machine 10 that requires refrigeration, require more power than a vending machine that dispenses a product that does not require refrigeration. As depicted in the Figures, the multiplicity of batteries 28 is placed in four rows of fours batteries, or sixteen batteries.

The multiplicity of batteries 28 is rechargeable. As the multiplicity of batteries 28 is drained, the multiplicity of batteries 28 is recharged via an alternative energy source (the solar power frame). Similarly, the multiplicity of batteries 28 is recharged via a traditional power source (AC from the power grid) when the solar power frame is unavailable or for vending units not having the solar power frame.

The battery bank assembly 12 includes an inverter 24. The inverter 24 is configured to convert the direct current (DC) from the multiplicity of charged batteries 28 into alternating current (AC) in a clean sinusoidal form at the appropriate frequency, which the vending machine 10 is originally configured to utilize. To perform this conversion, the inverter 24 is electrically coupled between the multiplicity of batteries 28 and an AC breaker box 22.

The battery bank assembly 12 includes a combiner 18 to combine the multiple inputs from the multiple solar panels 30 in the solar panel array (depicted in FIGS. 6, 7, and 8). As such the combiner 18 is electrically coupled to a controller 16, DC disconnect 20, and the multiplicity of batteries 28.

The battery bank assembly 12 includes a DC disconnect 20. The DC disconnect 20 allows one to the inverter 24 from the photovoltaic, solar power source, arriving through combiner 18 and change controller 16. A DC disconnect 20 allows one to stop and start the overall system should need to do so arise.

The battery bank assembly 12 further includes casters 26. The casters 26 provide easy transportability of the battery bank assembly 12. As shown four casters 26 provide support to the battery bank assembly 12 on each corner of the base. The type and number of casters 26 can vary based upon the size and weight of cabinet housing 13 and the size, number, and weight of the components, such as the bank of batteries 28, stored within.

In at least one embodiment, the battery bank assembly 12 is configured for use without coupling to the solar power frame 14. The battery bank assembly 12 in this embodiment is charged via a traditional power source at an earlier time. With a full charge, the battery bank assembly 12 is transported to and coupled with a vending machine, or like device, that needs to be powered for a day, or other predetermined time period when there is no traditional power source to supply power to the vending machine 10.

The battery bank assembly 12 is portable and once charged can be transported to a remote location, such as a fairgrounds or park, where there is no traditional power source. Upon coupling the battery bank assembly 12 to the vending machine 10, the machine 10 is powered. This embodiment is suitable for circumstances in which a vending machine needs to be powered for a day, or other predetermined time period, and no other power source is available.

Referring now to FIGS. 6, 7, and 8, schematic diagrams including a top planar view, side planar view, and end planar view, respectively, of a portable solar power frame 14 are shown. The solar power frame 14 is configured for connectivity to and use with the battery bank assembly 12 depicted in FIG. 2 in order to power the vending machine 10 depicted in FIG. 1.

The solar power frame 14 includes a multiplicity of solar panels 30. As depicted the solar power frame 14 includes six solar panels 30 arranged in a two-by-three grid. The six solar panels 30 are coupled one to another in a solar panel array. The arrangement and number of the solar panels 30 can vary based on power needs of the machine 10 supported and manufacturing considerations. By way of example, some vending machines, such as a cola machine 10 that requires refrigeration, require more power than a vending machine that dispenses a product that does not require refrigeration. Additionally, the number and placement of the solar panels 30 in the solar panel array can be varied in order to optimize the capture of sunlight.

In at least one embodiment, the solar power frame 14 is mounted to a top surface of the vending machine 10 such that they can be moved to obtain a better angle to the sun. Additionally, with this placement, the solar power frame 14 is not in the way of a user utilizing the vending machine. Furthermore, with this placement the solar power frame 14 is out of reach of most persons, thus avoiding both the potential for intentional vandalism and the handling of sensitive equipment, such as the photovoltaic components, by the curious observer.

The solar power frame 14 is configured to capture sunlight and convert the captured sunlight into electricity. Thus the solar power frame 14 provides solar power in direct current (DC) to charge the multiplicity of rechargeable batteries 28. Once charged the multiplicity of rechargeable batteries 28 is configured to adequately power the vending machine 10 or other electrical device.

The solar power frame 14 includes a multiplicity of drop-down hinges 32, or like devices. A drop-down hinge 32 is coupled to a pair of solar panels 30. The drop-down hinge 32 allows for the folding of the solar power array formed by the multiplicity of solar panels 30. As depicted in FIG. 6, which illustrates a two-by-three solar panel array, seven drop-down hinges 32 are utilized to allow each solar panel 30 to fold relative to an adjacent solar panel. The number of drop-down hinges 32 can vary.

In the solar power frame 14 depicted in FIG. 6, the solar array can be folded vertically in half, and then horizontally in thirds, or alternatively, horizontally in thirds and then vertically in half. Once folder for transport, the length and width of the folded array is the length and width of a single solar panel 30 and the height generally of six panels 30.

In at least one embodiment, a solar panel array is configured to fold to one stack of six panels 30, thereby providing compactness and portability. The solar panel array is configured to be lightweight such that one person can work with the array and “retrofit” an existing vending machine.

The solar power frame 14 includes multiple support legs 34. The support legs 34 are removable and foldable in various embodiments. The support legs 34 are configured to lock in place when in use or when in storage. The support legs 34 also provide for placement upon top, for example, of a vending machine 10, without being directly against it or thereby obtaining heat from the vending machine 10 which may cause harm over time to the solar power frame 14.

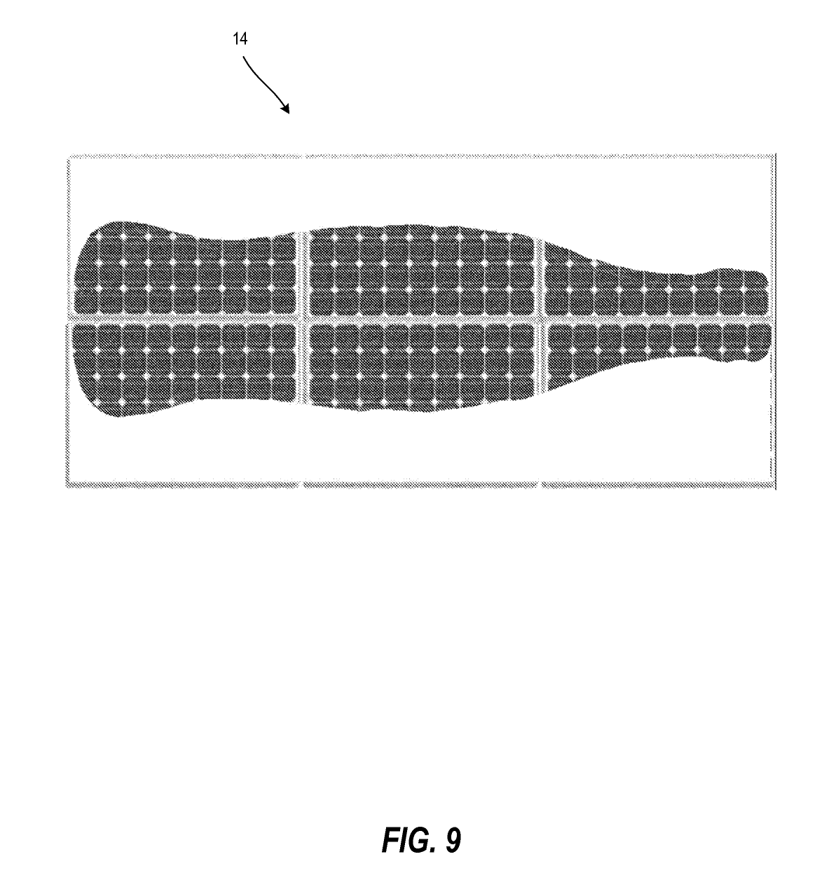

Referring now to FIG. 9, is a schematic diagram, top planar view, of the portable solar power frame 14 depicted in FIG. 6, wherein the solar panel array is further configured to provide an advertisement, logo, text, or the like, is shown. In this particular Figure, a bottle shape solar panel array 14 for use with a cola vending machine is shown. The shapes, designs, advertisement, logos, text, and the like can vary dependent upon the type of items vending and other factors determined by the machine owner or other circumstances.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A portable battery bank assembly comprising:
a portable battery bank having a plurality of rechargeable batteries electrically coupled to one another and configured to store power for supplying power to an existing vending machine or electrically powered device; and
a wiring harness configured to electrically couple the portable battery bank assembly to an existing vending machine or electrically powered device;
wherein a number of batteries comprising the plurality of rechargeable batteries is variable based upon the power demand of the existing vending machine or electrically powered device; and
wherein the portable battery pack assembly is configured as a retrofit device to an existing vending machine or electrically powered device.

2. The battery bank assembly of claim 1, further comprising:
an inverter configured to convert the DC power from the plurality of rechargeable batteries into AC power which the electrically powered device is originally configured to utilize.

3. The battery bank assembly of claim 1, further comprising:
a combiner configured to combine a plurality of inputs from a plurality of solar panels in a solar panel array;
wherein the plurality of rechargeable batteries of the portable battery pack assembly is configured to be charged from the plurality of solar panels in the solar panel array.

4. The battery bank assembly of claim 1, further comprising:
a portable housing cabinet configured to house the portable battery bank having a plurality of rechargeable batteries electrically coupled to one another and configured to store power for supplying power to an existing vending machine or electrically powered device;
wherein the portable housing cabinet is configured to be coupled mechanically to the existing vending machine or electrically powered device.

5. The battery bank assembly of claim 4, further comprising:
a plurality of casters coupled to a base of the portable housing cabinet and configured to provide easy transportability of the battery bank assembly and upon which the portable housing cabinet is rolled.

6. The battery bank assembly of claim 1, wherein the portable battery pack assembly is integrally formed with a new vending machine or electrically powered device and is not a retrofit device for an existing vending machine or electrically powered device.

7. A portable solar power frame assembly comprising:
a portable solar power frame having a plurality of solar panels coupled one to another in a solar panel array;
wherein the portable solar power frame is configured to capture sunlight and convert the captured sunlight into electricity, thereby to provide solar power to charge a battery bank and power a vending machine or other electrical device; and
wherein the portable solar power frame is configured as a retrofit device to an existing vending machine or electrically powered device.

8. The portable solar power frame assembly of claim 7, further comprising:
a plurality of drop-down hinges disposed upon the portable solar power frame and configured to provide for the folding of the solar power array formed by the plurality of solar panels.

9. The portable solar power frame assembly of claim 7, further comprising:
a plurality of removable, foldable support legs disposed upon the portable solar power frame and configured to provide portability and foldability.

10. The portable solar power frame assembly of claim 9, wherein the plurality of removable, foldable support legs is configured to lock in place when in use or when in storage.

11. The portable solar power frame assembly of claim 7, wherein the solar panel array comprises six solar panels; and wherein the solar panel array is configured to fold to one stack of a height of the six panels, thereby providing compactness and portability.

12. The portable solar power frame assembly of claim 7, wherein the solar panel array is further configured to be formatted to provide a resemblance to an advertisement, stylized design, logo, or text.

13. The portable solar power frame assembly of claim 7, wherein the portable solar power frame is integrally formed with a new vending machine or electrically powered device and is not a retrofit device for an existing vending machine or electrically powered device.

14. A combined portable solar power frame and portable battery pack assembly comprising:
a portable solar power frame having a plurality of solar panels coupled one to another in a solar panel array;
wherein the portable solar power frame is configured to capture sunlight and convert the captured sunlight into electricity, thereby to provide solar power to charge a battery bank and power a vending machine or other electrical device; and
a portable battery bank having a plurality of rechargeable batteries electrically coupled to one another and configured to store power for supplying power to the existing vending machine or electrically powered device; and
a wiring harness configured to electrically couple the portable battery bank assembly to the existing vending machine or electrically powered device;
wherein a number of batteries comprising the plurality of rechargeable batteries is variable based upon the power demand of the existing vending machine or electrically powered device; and
wherein the portable battery pack assembly and the portable solar power frame are configured as a retrofit device to an existing vending machine or electrically powered device.

15. The combined portable solar power frame and portable battery pack assembly of claim 14, further comprising:
a plurality of drop-down hinges disposed upon the portable solar power frame and configured to provide for the folding of the solar power array formed by the plurality of solar panels.

16. The combined portable solar power frame and portable battery pack assembly of claim 14, further comprising:
a plurality of removable, foldable support legs disposed upon the portable solar power frame and configured to provide portability and foldability;
wherein the plurality of removable, foldable support legs is configured to lock in place when in use or when in storage.

17. The combined portable solar power frame and portable battery pack assembly of claim 14, further comprising:
an inverter configured to convert the DC power from the plurality of rechargeable batteries into AC power which the electrically powered device is originally configured to utilize.

18. The combined portable solar power frame and portable battery pack assembly of claim 14, further comprising:
a combiner configured to combine a plurality of inputs from a plurality of solar panels in a solar panel array;
wherein the plurality of rechargeable batteries of the portable battery pack assembly is configured to be charged from the plurality of solar panels in the solar panel array.

19. The combined portable solar power frame and portable battery pack assembly of claim 14, further comprising:
a portable housing cabinet configured to house the portable battery bank having a plurality of rechargeable batteries electrically coupled to one another and configured to store power for supplying power to an existing vending machine or electrically powered device; and
a plurality of casters coupled to a base of the portable housing cabinet and configured to provide easy transportability of the battery bank assembly and upon which the portable housing cabinet is rolled;
wherein the portable housing cabinet is configured to be coupled mechanically to the existing vending machine or electrically powered device.

20. The combined portable solar power frame and portable battery pack assembly of claim 14, wherein combined portable solar power frame and portable battery pack assembly are integrally formed with a new vending machine or electrically powered device and are not a retrofit device for an existing vending machine or electrically powered device.
